(19) United States
(12) Patent Application Publication
(10) Pub. No.: US 2011/0109551 A1
(43) Pub. Date: May 12, 2011

(54) PROMOTIONAL MOUSE PRE-LOADED TO LAUNCH PRE-SELECTED WEBSITE

(76) Inventor: BAOQING ZHOU, SHENZHEN CITY (CN)

(21) Appl. No.: 12/909,844

(22) Filed: Oct. 22, 2010

(30) Foreign Application Priority Data
Nov. 6, 2009 (CN) 200920279057.4

(51) Int. Cl. G09G 5/08

(52) U.S. Cl. 345/163

(57) ABSTRACT

The present invention provides a computer mouse that provides a one-touch access to a preselected website on the Internet. The computer mouse comprises a shell having a label or other indicia corresponding to a preselected website arranged on the shell, a communication interface for connecting with the computer, and a circuit part arranged in the shell, wherein the circuit part comprises a microprocessor. The mouse further comprises a touch-operated Internet access key provided on the shell for connecting the computer to the preselected website, and wherein the Internet key is connected with the microprocessor of the circuit part, whereby when the Internet key is touched, the microprocessor communicates with the computer to direct the computer to the preselected website.

### CROSS-REFERENCE TO RELATED APPLICATIONS

The present application claims the priority benefit of Chinese utility model patent application serial number 200920279057.4 filed on 6 Nov. 2009.

### TECHNICAL FIELD

The invention relates to a computer peripheral device, in particular to a computer mouse that is pre-loaded with instructions to launch a pre-selected website.

### BACKGROUND

A mouse and a keyboard are the most used computer input devices. The present-day mouse normally is provided for only the realization of basic functions, and its structure usually comprises a shell, a circuit part arranged within the shell, and a communication interface for connecting with an external device. The circuit part often includes a left button, a right button, a roller, an optical or mechanical coordinate induction, and a microprocessor. The communication interface can be a wired USB interface, a wireless Bluetooth® interface, etc. The microprocessor typically converts the detected actions of the left button, the right button, the roller and the optical or mechanical coordinate induction into corresponding electric signals and forms information signals and transmits the related information signals to a connected computer through the communication interface.

Moreover, present-day computer keyboards sometimes are provided with a special Internet key for accessing the Internet via a one key action. However, for a computer device with a compact structure, such as a portable computer, a notebook, a palm computer and the like, the Internet access key is neither economical nor practical.

A multifunction mouse pad disclosed in Chinese Patent document ZL200420088509.8 arranges the one key Internet function on the mouse pad, and comprises a central processing chip, a USB interface connected with a computer mainframe, a one key Internet function key and the like. However, the method of making the mouse pad into a multifunctional electronic device can greatly increase cost, and the mouse pad is not an essential item in many occasions, thus becoming encumbrance for a computer device user and greatly restricting the application range.

### SUMMARY OF THE INVENTION

Embodiments of the present invention provides a computer mouse that provides a one-touch access to a preselected website on the Internet. Briefly described, in architecture, one embodiment of the computer mouse, among others, can be implemented as follows.

The computer mouse includes a shell having a label or other indicia corresponding to a preselected website arranged on the shell, a communication interface for connecting with the computer, and a circuit part arranged in the shell, wherein the circuit part comprises a microprocessor. The mouse further includes a touch-operated Internet access key provided on the shell for connecting the computer to the preselected website, and wherein the Internet key is connected with the microprocessor of the circuit part, whereby when the Internet key is touched, the microprocessor communicates with the computer to direct the computer to the preselected website.

Generally described, in a preferred form the present invention relates to a computer mouse that provides a one-touch access to a preselected website on the Internet. Preferably, the mouse is preloaded with instructions to direct the computer to the preselected website in response to the user touching a particular part of the mouse. Preferably, the mouse is provided with a button or switch or touch zone that has a trademark or other indicia associated thereat. Thus, the mouse displays the trademark or other indicia and when the user touches the trademark or indicia (or near thereto), the user's computer is directed to a website associated with the trademark or indicia. In this way, a mouse is provided that provides a one-touch access to a preselected website and also promotes both the preselected website and the trademark or indicia.

Stated another way, the present invention comprises a computer mouse for use with a computer and includes a shell with a label or other indicia corresponding to a preselected website arranged on the shell. A communication interface is provided in the mouse for connecting with the computer and a circuit part is arranged in the shell. Preferably, the circuit part comprises a microprocessor. A touch-operated Internet access key is provided on the shell for directly linking the computer to the preselected website. Preferably the Internet key is connected with the microprocessor of the circuit part, and when the Internet key is touched, the microprocessor communicates with the computer to direct the computer to the preselected website.

Optionally, the touch-operated Internet access key comprises a capacitance-type sensor or an inductance-type sensor. Also optionally, the touch-operated Internet access key can comprise an induction area and a touchdown area, wherein the touchdown area surrounds the periphery of the induction area, and a uniform isolating clearance is arranged between the touchdown area and the induction area.

Optionally, the microprocessor determines that the label is effectively touched when the microprocessor detects that the Internet access key has been double-clicked in a time interval of between about 0.2 to 0.8 seconds.

Optionally, the communication interface can comprise a USB wire cable connector which extends out from one end of the shell. Also optionally, the circuit part also can comprise a card reader arranged at one end of the shell.

The specific techniques and structures employed to improve over the drawbacks of the prior devices and accomplish the advantages described herein will become apparent from the following detailed description of example embodiments and the appended drawings and claims. Other embodiments and aspects of the invention are described in detail herein and are considered a part of the claimed invention.

### BRIEF DESCRIPTION OF THE DRAWINGS

FIG. 1 is a perspective view of a computer mouse according to a first example embodiment of the present invention.

FIG. 2 is a front view of the mouse of FIG. 1.

FIG. 3 is a perspective, exploded view of the mouse of FIG. 1.

FIG. 4 is a schematic functional block diagram of the mouse of FIG. 1.

### DETAILED DESCRIPTION

Generally described, in a preferred form the present invention relates to a computer mouse that provides a one-touch access to a preselected website on the Internet. Preferably, the mouse is preloaded with instructions to direct the computer to the preselected website in response to the user touching a particular part of the mouse. Preferably, the mouse is provided with a button or switch or touch zone that has a trademark or other indicia associated thereat. Thus, the mouse displays the trademark or other indicia and when the user touches the trademark or indicia (or near thereto), the user's computer is directed to a website associated with the trademark or indicia. In this way, a mouse is provided that provides a one-touch access to a preselected website and also promotes both the preselected website and the trademark or indicia.

Stated another way, the present invention comprises a computer mouse for use with a computer and includes a shell with a label or other indicia corresponding to a preselected website arranged on the shell. A communication interface is provided in the mouse for connecting with the computer and a circuit part is arranged in the shell. Preferably, the circuit part comprises a microprocessor. A touch-operated Internet access key is provided on the shell for directly linking the computer to the preselected website. Preferably the Internet key is connected with the microprocessor of the circuit part, and when the Internet key is touched, the microprocessor communicates with the computer to direct the computer to the preselected website.

Optionally, the touch-operated Internet access key comprises a capacitance-type sensor or an inductance-type sensor. Also optionally, the touch-operated Internet access key can comprise an induction area and a touchdown area, wherein the touchdown area surrounds the periphery of the induction area, and a uniform isolating clearance is arranged between the touchdown area and the induction area.

Optionally, the microprocessor determines that the label is effectively touched when the microprocessor detects that the Internet access key has been double-clicked in a time interval of between about 0.2 to 0.8 seconds.

Optionally, the communication interface can comprise a USB wire cable connector which extends out from one end of the shell. Also optionally, the circuit part also can comprise a card reader arranged at one end of the shell.

Generally described, the present invention relates to a computer mouse that provides a one-touch access to a preselected website on the Internet. Preferably, the mouse is preloaded with instructions to direct the computer to the preselected website in response to the user touching a particular part of the mouse. Preferably, the mouse is provided with a button or switch or touch zone that has a trademark or other indicia associated thereat. The mouse displays the trademark or other indicia and when the user touches the trademark or indicia (or near thereto), the user's computer is directed to a website associated with the trademark or indicia.

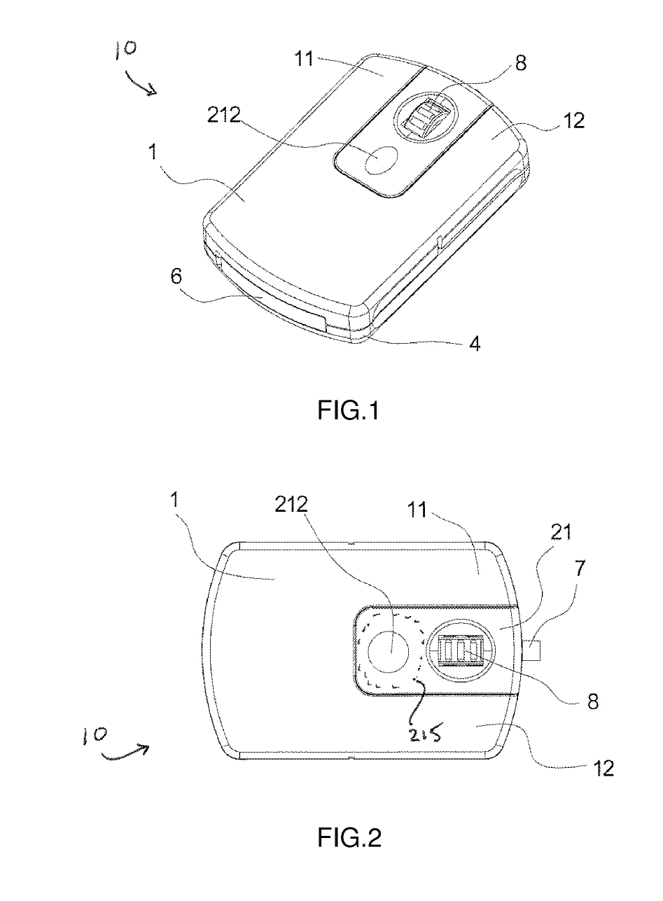

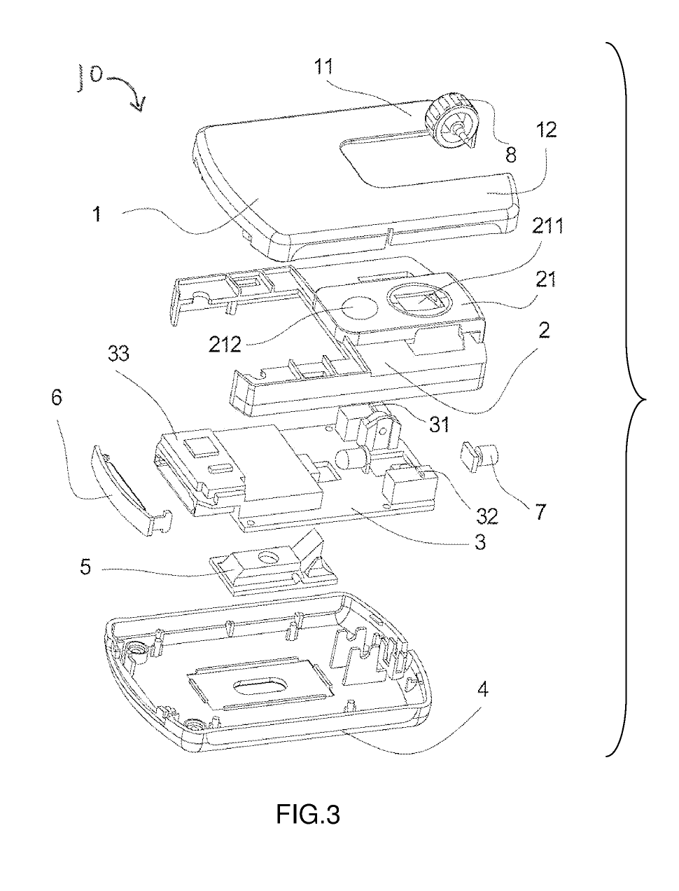

Turning now to the drawing figures, wherein like reference numerals represent like parts throughout the several views, FIGS. 1-3 show a computer mouse 10 according to a first example embodiment of the present invention. As shown in FIGS. 1-3, the mouse 10 comprises an upper shell 1, an inner frame 2, a circuit part 3, a lower shell 4, an optical component 5, a bottom cover 6, a wire cable 7, a roller 8 and the like. In an alternative embodiment, the wire cable may be replaced by a wireless connection such as, but not limited to Bluetooth.

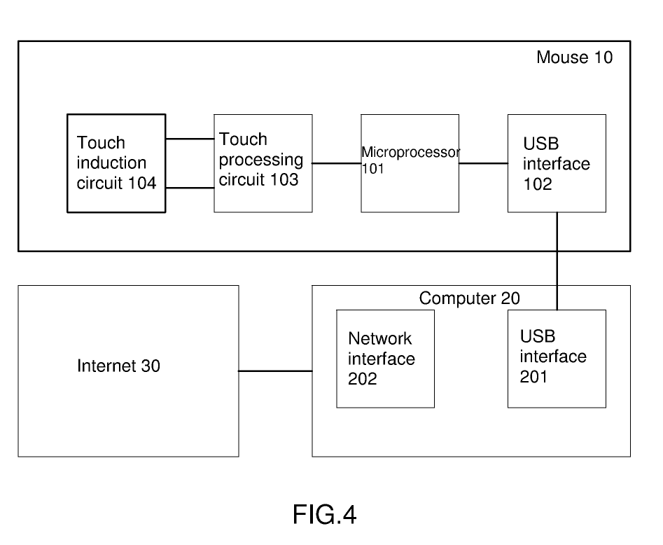

As shown in FIG. 4, the mouse 10 comprises a microprocessor 101 in circuit part 3, a USB interface 102, a touch processing circuit 103 in circuit part 3 and a touch induction circuit 104 that is also in circuit part 3. The touch processing circuit 103 and the touch induction circuit 104 together form a touch inductive Internet key 215 such that after the microprocessor 101 detects that the Internet key has been effectively touched, the microprocessor 101 communicates for linking the computer with the preselected website. To accomplish this, the mouse 10 is connected to an external device, for example, a computer 20 with a USB interface 201 through the USB interface 102. Typically, the computer 20 is connected with the Internet 30 through a network interface 202 and then webpage information on the special website is displayed on a screen of the computer 20. The microprocessor 101 launches the preselected website on the user's computer when it detects that the Internet key has been effectively touched, or when it detects that the Internet key has been double-clicked in a time interval of 0.2 to 0.8 second. This design is ergonomic, highly functional, and tends to avoid operation errors or user errors.

In one form, the touch induction circuit 104 can be a capacitance type sensor which comprises an induction area and a touchdown area, wherein the touchdown area surrounds the periphery of the induction area, and a uniform isolating clearance is arranged between the touchdown area and the induction area. Such a capacitance type sensor and an inductive mouse are disclosed in Chinese patent 200820179101.X and need not be further described herein.

While the touch induction circuit 104 can be a capacitance type sensor, those skilled in the art will readily recognize that other switches or triggering devices can be employed to indicate that the user has touched the Internet access key. These other switches or triggering devices include, but are not limited to button, switch, trademark or other indicia. For example, instead of using a capacitance type sensor, a simple micro-switch can be positioned beneath the trademark or indicia to allow the user to trigger the switch by lightly pressing on the trademark or indicia. Likewise, the touch inductive Internet key 215 can comprise an inductance-type sensor. The particular type of switch or sensor employed is not critical.

Considering that the operating space of the mouse is quite small, the touch inductive key is selected for the Internet key, and compared with the generally adopted mechanical keys, the mouse not only can meet the practical requirements for stable and reliable operation, easy realization, low cost and the like, but also can achieve an integrated aesthetic appearance for the mouse.

The shell of the mouse 10 comprises the upper shell 1, the lower shell 4, and the inner frame 2 which is positioned between the upper shell 1 and the lower shell 4.

A left button plate 11 and a right button plate 12 are respectively formed on two sides of the front end of the upper shell 1 and an opening is formed in a position between the two key plates 11 and 12. A boss 21 is positioned and sized to correspond to the opening and is arranged on the inner frame 2. The boss 21 is positioned generally in the opening and the upper surface of the boss 21 is generally flush with the upper surface of the upper shell. A roller window or aperture 211 corresponds to the roller 8 and is arranged on the boss 21. A label or trademark 212 is arranged adjacent to and behind the roller window 211. The touch inductive Internet key 215 is correspondingly arranged in or on the shell 1 adjacent the label or trademark 212 and extends beyond the label or trademark 212. In the event that a large label or trademark is to be used, the touch inductive Internet key 215 can extend beyond a central or main part of the label or trademark.

By arranging the label or trademark 212 on the shell corresponding to the induction area of the touch inductive Internet key 215, a user can associate the label or trademark 212, the mouse 10 and the specific website together. For example, the label or trademark 212 can printed or adhered on the shell of the mouse 10 and can be a specific logo or name of a product supplier or service provider. Further, the preselected website programmed in the mouse 10 is the specific service webpage of the product supplier or service provider. Optionally, the product supplier or service provider can present the mouse 10 as a gift to clients, customers, potential customers, etc. of the product supplier or service provider. Thus, through the dissemination and use of the mouse 10, an effective and tangible connection can be made or shown between the product supplier or service provider and the clients, customers, or potential customers. Thus, users of the mouse 10 can directly enter the enterprise website to be promoted simply by touching just the enterprise logo at the label or trademark 212 on the mouse 10. Thus, for the product supplier/service provider, the mouse 10 can be an effective marketing and advertising vehicle, while providing a highly functional input device for the user.

In addition to the microprocessor 101, the USB interface 102, the touch processing circuit 103 and the touch induction circuit 104, the circuit part 3 also optionally comprises a left button 31, a right button 32 and a card reader 33. A card plug-in window corresponds to an input port of the card reader 33 and is arranged at the back end of the shell. A bottom cover 6 is correspondingly arranged at the card plug-in window. Such an optional design can enable the mouse 10 to have a card reader function and provide further convenience for users.

It is to be understood that this invention is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the claimed invention has been shown and described in example forms, it will be apparent to those skilled in the art that many modifications, additions, and deletions can be made therein without departing from the spirit and scope of the invention as defined by the following claims.

What is claimed is:

1. A computer mouse for use with a computer, the mouse comprising:
a shell having a label or other indicia corresponding to a preselected website arranged on the shell;
a communication interface for connecting with the computer;
a circuit part arranged in the shell, wherein the circuit part comprises a microprocessor; and
a touch-operated Internet access key provided on the shell for connecting the computer to the preselected website, and wherein the Internet key is connected with the microprocessor of the circuit part, whereby when the Internet key is touched, the microprocessor communicates with the computer to direct the computer to the preselected website.

2. A mouse as claimed in claim 1, wherein the touch-operated Internet access key comprises a capacitance-type sensor.

3. A mouse as claimed in claim 1, wherein the touch-operated Internet access key comprises an inductance-type sensor.

4. A mouse as claimed in claim 1, wherein the touch-operated Internet access key comprises an induction area and a touchdown area, wherein the touchdown area surrounds the periphery of the induction area, and a uniform isolating clearance is arranged between the touchdown area and the induction area.

5. A mouse as claimed in claim 4, characterized in that the label or indicia is printed or affixed on the shell, the Internet access key is arranged in the shell corresponding to the label or indicia, and the area of the label or indicia corresponds to the induction area of the Internet key.

6. A mouse as claimed in claim 1, wherein the microprocessor determines that the label is effectively touched when the microprocessor detects that the Internet access key is double-clicked in a time interval of between about 0.2 to 0.8 seconds.

7. A mouse as claimed in claim 1 further comprising a roller positioned in a central position at the front upper end of the shell, and the label is arranged adjacent to and behind the roller.

8. A mouse as claimed in claim 7, wherein the shell comprises an upper shell, a lower shell, and an inner frame between the upper shell and the lower shell, and wherein an opening is arranged in a central position at the front end of the upper shell, the inner frame is provided with a boss correspondingly contained in the opening, the boss is provided with an installing window corresponding to the roller, and the label is arranged on the boss adjacent to the back part of the installing window.

9. A mouse as claimed in claim 7, characterized in that the upper surface of the boss is flushed with the upper surface of the upper shell.

10. A mouse as claimed in claim 8, characterized in that the communication interface comprises a USB wire cable connector which is led out from the front end of the shell.

11. A mouse as claimed in claim 9, characterized in that the circuit part also comprises a card reader, a card plug-in window corresponding to a plug-in port of the card reader is arranged at the back end of the shell.
